(19) United States
(12) Patent Application Publication
(10) Pub. No.: US 2013/0167337 A1
(43) Pub. Date: Jul. 4, 2013

(54) METHOD AND MACHINE TOOL FOR ADJUSTING THE CONTOUR OF A TURBINE BLADE ROOT

(71) Applicants: Olivier Dupouy, Levallois-Perret (FR); Christian Defrocourt, Franconville (FR); Thomas Marquoin, Chatenay Malabry (FR); Pascal Paul, Houille (FR)

(72) Inventors: Olivier Dupouy, Levallois-Perret (FR); Christian Defrocourt, Franconville (FR); Thomas Marquoin, Chatenay Malabry (FR); Pascal Paul, Houille (FR)

(73) Assignee: SNECMA, Paris (FR)

(21) Appl. No.: 13/822,849

(22) PCT Filed: Sep. 15, 2011
(86) PCT No.: PCT/FR11/52131

§ 371 Date: Mar. 13, 2013

(30) Foreign Application Priority Data
Sep. 15, 2010 (FR) 10 57384

(51) Int. Cl. B23P 13/00

(52) U.S. Cl. CPC B23P 13/00
USPC 29/23.51; 29/889.7

(57) ABSTRACT

A method for adjusting a predetermined contour of a turbine blade root including a main salient edge defined by a determined interior angle. The method includes: chamfering the main edge of the contour to obtain two auxiliary salient edges, associated interior angles of which are respectively greater than the interior angle of the main edge; and blunting the auxiliary edges obtained to fine-tune the contour of the blade root.

The present invention relates to the field of adjusting a part. More specifically, the invention relates to a method for adjusting the contour of a turbine blade root, the latter comprising a main salient edge defined by a determined interior angle.

In the following,
“salient edge” should be understood as the line formed by the intersection of two surfaces of the blade root to be adjusted;
“interior angle of a salient edge” should be understood as the angle defined between the two surfaces forming the edge; and
“complex contour” should be understood as a sinuous line having a succession of peaks and troughs.

It is known that, after the process of machining a turbine blade root, each profile of the root is bounded by a contour having a salient edge (the associated interior angle of which is a right angle) which must be removed in an adjusting process.

In a known manner, adjusting a blade root is currently carried out manually by a qualified operative who shapes, for example using a carbide milling bit and a brush, the complex contour of the profile of the blade root in order to blunt the salient edge and round it off to an arc of a circle. (Such an adjustment is also referred to as a “radiusing”).

However, as the adjusting process is a manual one, the dimensions of different blade roots adjusted by a same operative are often found to be different. These differences are generally found in the rounding obtained (after milling and brushing of the salient edge), which is different from one blade root to another (the radius of the rounding varies between the adjusted blade roots).

Furthermore, when the blade roots have been inadequately or imprecisely adjusted (for example if the salient edge has not been blunted enough), this can affect the blade-root manufacturing processes which follow the adjusting process. For example, the shot peening process applied to an adjusted blade root, the salient edge of a profile contour of which has not been adequately rounded, suffers as some of the peening shot is deflected by this improperly blunted edge.

Furthermore, the fact that the dimensions of the blade roots are not all identical makes it more difficult to mount the blades on the corresponding support disk of the high-pressure turbine.

In addition, the adjusting process is carried out manually, which increases the overall production cost for the blade roots. What is more, this production process frequently causes physiological trauma, in the form of MSDs (musculoskeletal disorders), in the operatives.

As well as the abovementioned drawbacks, where a blade root continues to have salient edges after adjustment, these can promote the development of cracks in parts engaging with said blade root, and may lead to failure of said parts.

Hence, in an attempt to mitigate the abovementioned drawbacks, it is known practice to use a six-axis robotic arm for the purpose of carrying out automatic adjustment of the profile contours of a blade root.

However, programming such a robotic arm proves to be long-winded and the reproduction of an operative's movements is often less than perfect. Furthermore, the high cost of the robotic arm is one reason for this automatic adjustment being unsuitable in the vast majority of cases.

The aim of the present invention is to solve these drawbacks. To that end, according to the invention, the method for adjusting a predetermined contour of a turbine blade root comprising a main salient edge defined by a determined interior angle is noteworthy in that the following successive steps are performed:

A/ the main edge of the contour is chamfered in order to obtain two auxiliary salient edges, the associated interior angles of which are respectively greater than the interior angle of the main edge; and

B/ the auxiliary edges obtained are blunted in order to fine-tune the contour of the blade root.

Thus, by virtue of the invention, the chamfer effected on the main salient edge gives rise to two auxiliary edges which are less sharp, such that removing these edges is made considerably easier. Whatever the depth of the chamfer effected on the main edge, the adjusting process of the invention gives rise to a straight-line portion (also termed chamfer line) on the curvature of the contour defined in a plane perpendicular thereto. The greater the depth of the chamfer, the longer the chamfer line. Moreover, the chamfer line is at least partially reduced when the two auxiliary edges are removed. Thus, the curvature of the contour, in a plane perpendicular thereto, has an acceptable rounded shape.

According to one embodiment in line with the present invention, although steps A/ and B/ can be carried out manually, they are advantageously implemented automatically, which makes it possible to achieve uniform adjustment over all of the one or more contours of the blade root. Moreover, the adjustment process of the invention can be faithfully reproduced on a plurality of identical blade roots, which will then have substantially similar adjusted contours. In addition, the involvement of an operative is reduced, (for example to placing the blade root in question in a suitable recess), thus reducing the risk of said operative developing MSDs.

Preferably, the blade root to be adjusted is clamped beforehand.

What is more, the blade root can advantageously be clamped to means mounted so as to rotate about an axis, so that the adjustment process of the invention is made easier.

Again preferably, before step A/ is implemented and after the blade root has been clamped, the predetermined contour of the blade root is probed in order to determine a predefined origin on this contour from which the chamfering of step A/ is begun.

Furthermore, in one embodiment according to the invention, the interior angles respectively associated with the auxiliary edges are identical.

In addition, as an illustrative but non-limiting example, the interior angles of the main and auxiliary edges are equal to 90° and 135° respectively.

In another embodiment according to the invention, step B/ is carried out by brushing the auxiliary edges.

Such a brushing of step B/ can be carried out using a rotating circular brush having crimped bristles.

The crimped bristles of the circular brush can, for example, be made of nylon, although any other desired material can still be envisaged.

Moreover, the circular brush is advantageously driven in rotation by a longitudinal shaft substantially perpendicular, on the one hand, to the general direction of the crimped bristles and, on the other hand, to that portion of each of the auxiliary edges currently being brushed. Thus, the bristles of the circular brush rotate in a plane of rotation that is substantially parallel to each of the auxiliary edges. The brushing of the circular brush arranged in this way is in particular made possible by the crimping of the bristles of the brush.

Furthermore, the present invention also relates to a machine tool for adjusting a predetermined contour of a turbine blade root comprising a main salient edge defined by a determined interior angle, which is noteworthy in that it comprises:
means for chamfering the main edge of the contour, in order to obtain two auxiliary salient edges, the associated interior angles of which are respectively greater than the interior angle of the main edge;
means for blunting the auxiliary edges obtained, in order to fine-tune the contour of the blade root; and
means for automatically controlling the chamfering means and the blunting means.

Thus, the chamfer obtained on the contour in question of a blade root is uniform and the auxiliary edges are blunted in a substantially identical fashion over the whole contour. Moreover, the adjustment can be repeated identically on a plurality of blade roots, in order to obtain parts with adjusted contours which are substantially similar to each other.

Of course, as a variant, the chamfering means and the means for blunting can be controlled manually by a qualified operative.

Furthermore, the machine tool preferably comprises means, mounted so as to rotate about an axis, to which means is clamped the blade root to be adjusted and which means may comprise at least one detachable clamping module suitable for gripping the blade root to be adjusted.

A clamping module of this type may comprise contact members designed to press against the blade root to be adjusted.

The figures of the attached drawing will explain clearly how the invention can be implemented. In these figures, identical references denote similar elements.

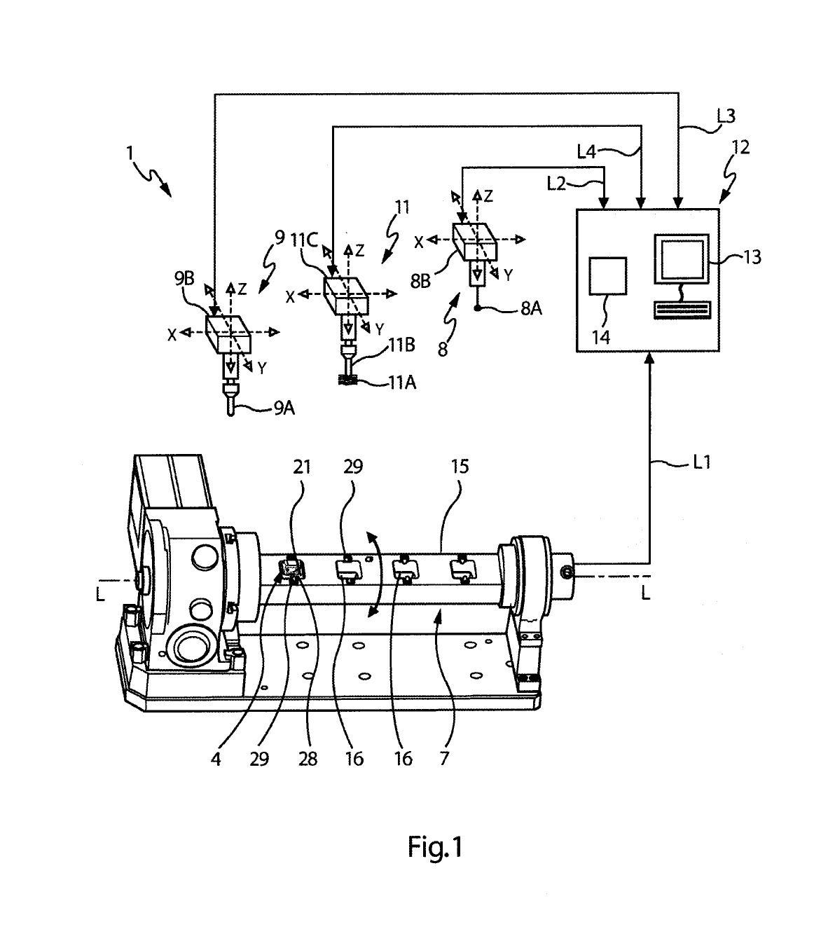

FIG. 1 is a synoptic diagram of a machine tool, in accordance with the present invention, for adjusting one or more contours of a machined turbine blade root.

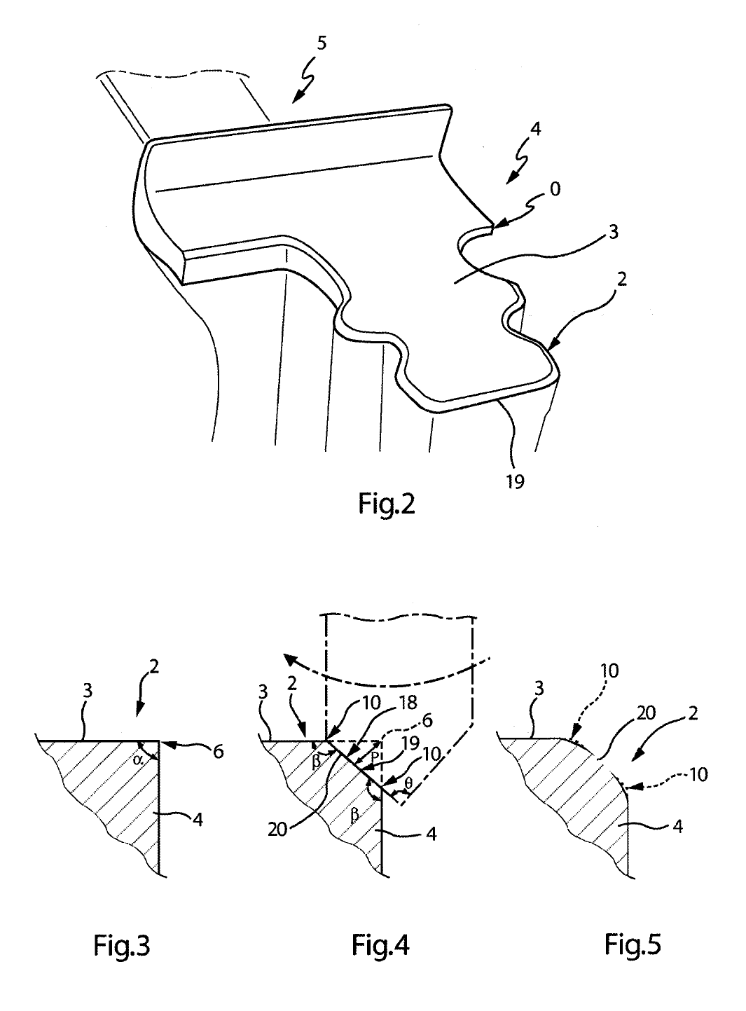

FIG. 2 shows, in a perspective view from above, the profile of a blade root of a high-pressure turbine, the contour of which has been adjusted by the machine tool of FIG. 1, in accordance with the invention.

FIGS. 3 to 5 illustrate the curvature of the contour of the profile of a blade root respectively before chamfering (FIG. 3), after chamfering (FIG. 4) and after brushing (FIG. 5), in accordance with the present invention.

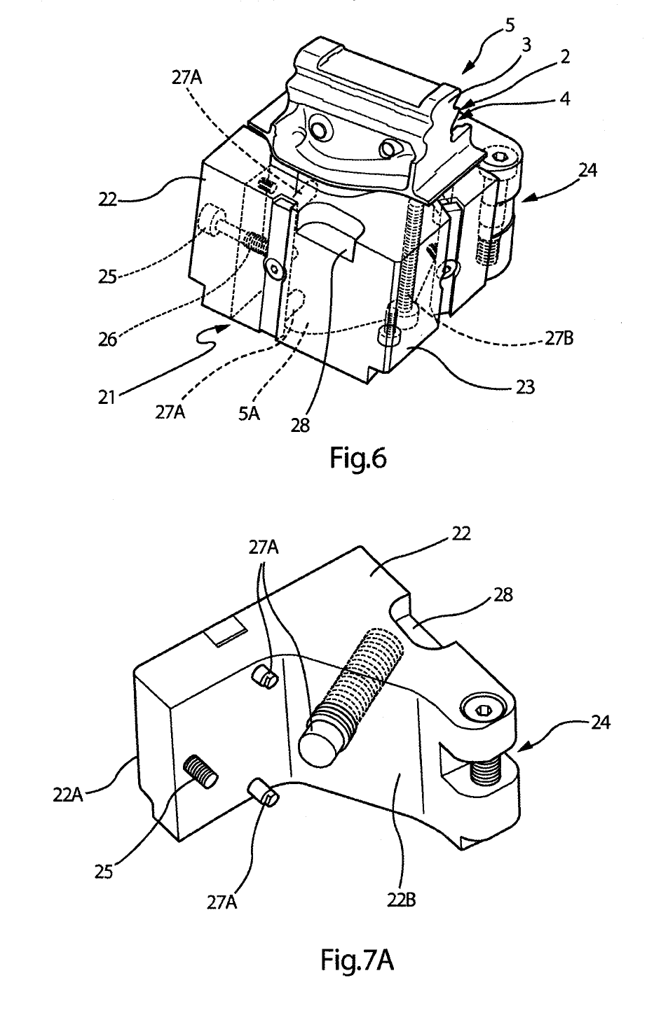

FIG. 6 shows, in a schematic perspective view, an example of a module for clamping a blade intended to be accommodated in a moving part-support, integrated into the machine tool of FIG. 1.

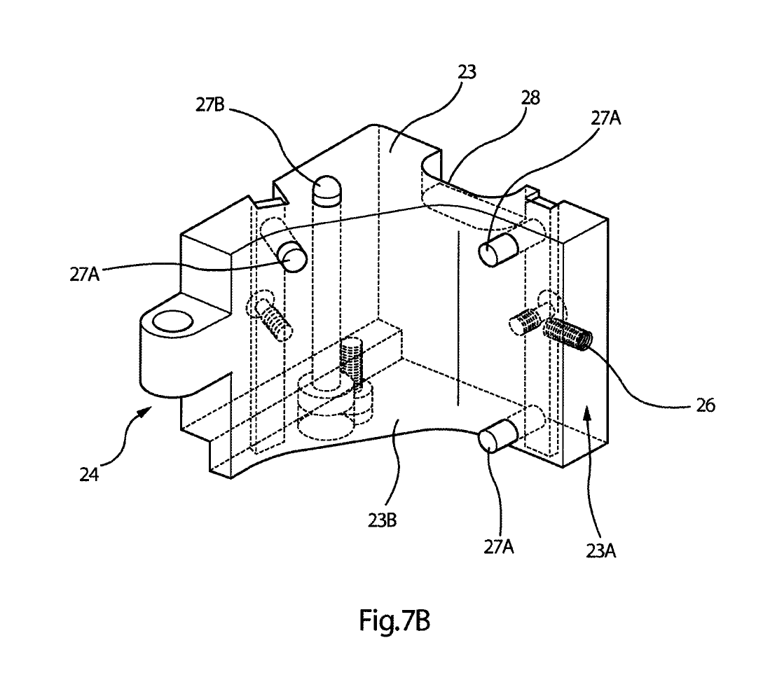

FIGS. 7A and 7B represent, in a schematic perspective view, respectively the two pressure-face and suction-face shells of the clamping module of FIG. 6.

FIG. 1 shows, in the form of a synoptic diagram, a numerically controlled machine tool 1, in accordance with the present invention, for adjusting the contour of a machined turbine blade root.

In the following, as an illustrative but non-limiting example, the adjustment of the complex contour 2 of the profile 3 of the root 4 of a high-pressure turbine blade 5 for an airplane engine is considered (FIG. 2).

In addition, in this example, the contour 2 of the profile 3 of the blade root 4 has, before adjustment, a main salient edge 6 the interior angle α of which is essentially a right angle (i.e. equal to 90°). In other words, the curvature of the contour, defined in a plane perpendicular thereto, has a right angle (FIG. 3).

As shown in FIG. 1, the machine tool 1 of the invention comprises the following means:
means 7 for clamping a blade 5 onto the machine tool 1, which means are mounted so as to rotate about a longitudinal axis L;
means 8 (hereinafter termed probe) for probing the predetermined contour 2 of a profile of the root of the clamped blade 5, in order to detect a predefined origin O on this contour 2 (FIG. 2);
means 9 for chamfering the main edge 6 of the contour 2 of the blade root 4 starting from the detected origin O, in order to obtain two auxiliary salient edges 10, the associated interior angles β of which are respectively greater than the interior angle α of the main edge 6 (FIG. 4);
means 11 for brushing the auxiliary edges 10 obtained after chamfering, in order to fine-tune the contour 2 of the profile of the blade root 4; and
means 12 for automatically controlling the means 7, the probe 8, the chamfering means 9 and the brushing means 11, to which means they are respectively connected by connections L1 to L4.

As shown in FIG. 1, the automatic control means comprise a man-machine interface 13, by means of which a program for adjusting the contour 2 of the blade root 4 can be configured by a qualified operative. Such a program, saved in a memory 14 of the means 12, comprises a sequence of movement and/or action instructions.

During configuration of the adjustment program, the operative defines the characteristics of the trajectory to be followed by the chamfering means 9 as a function of the contour 2 of the blade root 4. The origin for the trajectory is determined by the predefined origin O which the probe detects on the blade root 4.

Moreover, as shown in FIG. 1, the means 7 comprise a rectangular moving support 15, designed to rotate about the longitudinal axis L. The support 15 comprises several identical recesses 16 which are fashioned therein and are intended to receive in each case one removable clamping module 21 (each recess having a shape which is complementary to the clamping module 21). FIG. 1, for example, shows four recesses 16, such that the support 15 can accommodate four clamping modules 21 (and therefore four blades 5 to be adjusted).

Furthermore, as shown in FIGS. 6, 7A and 7B, each clamping module 21, designed to hold fast a blade 5, comprises two complementary shells 22 and 23, intended to press against the pressure-face and suction-face surfaces, respectively, of the blade 5 in order to grip the airfoil 5A thereof. It follows that the shells 22 and 23 (which act as a holding arm) are respectively designated as the pressure-face and suction-face shells.

The shells 22 and 23 are articulated to each other by means of a hinge 24, such that the clamping module 21 can open to receive a blade 5 and close to grip it, and vice versa. A tightening screw 25, mounted on the pressure-face shell 22 and intended to be screwed into a corresponding hole 26 of the suction-face shell 23, makes it possible to join the free ends 22A and 23A of the shells 22 and 23 respectively, once the blade 5 is in the correct position. Thus, the blade can be held gripped by the clamping module 21.

The pressure-face shell 22 has three internal lugs 27A (also termed contact members) which project from its inner face 22B, which are intended to press against the pressure face of the blade 5.

Similarly, the suction-face shell 23 has three internal lugs 27A which project from its inner face 23B, which are designed to press against the suction face of the blade 5. In other words, the clamping module 21 has six internal lugs 27A which form six small contact surfaces for contact with the blade 5, thus reducing the risk of recrystallization of the blade material.

It should be noted that the end of at least some of the internal lugs 27A can be shaped to exactly match the corresponding surface of the blade 5 (either pressure-face or suction-face surface).

In the example, the lugs 27A are mounted so as to be removable from shells 22 and 23, in order that they can be adjusted and/or replaced with another type of lug which is suited to another shape of blade. In other words, in this case, the clamping module 21 can, by means of simply adjusting and/or replacing the internal lugs, accommodate various blade shapes.

In addition, the suction-face shell 23 has an external lug 27B, which projects from one of its outer faces, on which lug the root 4 of the blade 5 can rest.

By means of the clamping module 21, the contour 2 of the profile 3 of the blade root 4 to be adjusted stands proud and is thus accessible for the purpose of the adjusting processes described below.

What is more, the clamping module 21 has two cutouts 28, respectively formed in the wall of each of the shells 22 and 23. Each cutout 28 can receive the free end of a locking tab 29 mounted so as to pivot, at its other end, on one of the edges of a recess 16 of the moving support 15.

Thus, the blade 5 to be adjusted is gripped beforehand in the clamping module 21, having been correctly positioned therein.

The clamping module 21 is then accommodated in one of the recesses 16 of the support 15, the corresponding locking tabs 29 having been moved clear. In order to clamp the module 21 to the support 15, the tabs 29 are brought into the corresponding cutouts 28 of the module 21.

Moreover, in the example of FIG. 1, the probe 8 has a probing head 8A mounted on a moving block 8B.

The moving block 8B of the probe 8 is designed to move along three mutually orthogonal axes X, Y, Z. The directions of the X and Y axes define a horizontal plane of movement for the moving block 8 and the direction of the Z axis characterizes a vertical movement thereof.

Advantageously, the longitudinal axis of rotation L of the support 15 is arranged perpendicular to the Z axis. Of course, other configurations of the X, Y, Z and L axes can also be envisaged.

The probe 8 makes it possible to calibrate the adjustment program by repositioning the means 9 on the origin O which is predefined for each blade root 4 to be adjusted, which makes it possible to take into account differences in the dimensions of the various blade roots adjusted in turn.

Furthermore, in this example, the chamfering means 9 take the form of a chamfer bit 9A (for example a carbide milling bit), the tip angle Θ of which is equal to 90°. The chamfer bit 9A is mounted on a moving block 9B, similar to that of the probe 8, such that it can also be moved along the three, X, Y and Z, axes.

Before the chamfering step, the bit 9A, controlled automatically by the control means 12, is advantageously positioned at the predefined origin O, perpendicular to the profile 3 of the blade root 4 to be adjusted. Thus, as shown in FIG. 4, chamfering produces auxiliary edges 10, the associated interior angles β of which are identical and equal to 135°.

Moreover, the depth p of the chamfer 18 produced, corresponding to the distance between the vertex of the main edge 6 and the beveled surface 19, in a direction perpendicular thereto, is determined during the configuration, beforehand, of the adjusting program.

As shown in FIGS. 4 and 5, whatever the depth p of the chamfer 18 produced, the chamfering according to the invention gives rise to a straight chamfer line 20 on the curvature of the contour 2 defined in a plane perpendicular thereto, this chamfer line 20 being longer the greater the depth p of the chamfer 18. Brushing the auxiliary edges 10 then makes it possible to shorten the chamfer line 20.

In addition, the brushing means comprise a circular rotating brush 11A having crimped bristles, which is driven in rotation by means of a longitudinal drive shaft 11B, perpendicular to the general direction of the crimped bristles.

What is more, in the example of FIG. 1, the drive shaft 11B is substantially parallel to the Z axis. The assembly formed by the brush 11A and the drive shaft 11B is mounted on a moving block 11C similar to that of the probe 8 such that the brush can be moved along the X, Y and Z axes.

In the example described, the combination of the brushing means 11, which can move along the X, Y and Z axes, and the means 7, mounted so as to rotate about the longitudinal axis L, makes it possible to adjust with precision the relative position of the brush 11A in relation to the auxiliary edges 10, so as to keep the plane of rotation of the crimped bristles of the brush 11A substantially parallel to that portion of each of the auxiliary edges 10 currently being brushed. Indeed, it is possible, by rotating the moving support 15, to adjust the inclination of the contour 2 of the profile 3 to be brushed relative to the plane of rotation of the brush 11A.

Thus, the machine tool 1 of the invention advantageously has only four axes of movement (X, Y, Z, L), such that the design and production thereof are greatly simplified.

Furthermore, as shown in FIG. 3, once the steps of chamfering and brushing have been carried out, the chamfer line 20 is reduced and the curvature of the contour 2 of the profile 3, in a plane perpendicular to said contour 2, has a substantially rounded shape.

By means of the invention, the chamfer 18, obtained on the contour 2 of the profile 3 of the blade root 4, is uniform and the auxiliary edges 10 are blunted in a substantially identical fashion over the whole contour 2.

Moreover, the machine tool 1 can repeat the abovementioned chamfering and brushing processes identically on a plurality of blade roots, in order to obtain blade roots having adjusted contours which are substantially similar to one another. Thus, the process of assembling the high-pressure turbine is made easier; at the same time, the reliability of said turbine is improved (as the risk of failure of the parts is reduced).

In addition, the invention means that a blade root to be adjusted need be subjected to the process only once (in contrast to adjusting processes which are performed manually), which makes it possible to reduce the time needed for the adjusting.

Furthermore, it may be noted that the machine tool 1 of the present invention can equally be used for brushing one or more portions of a blade root, in accordance with the brushing process described above, without implementing the chamfering process.

1-9. (canceled)

10. A method for adjusting a predetermined contour of a turbine blade root including a main salient edge defined by a determined interior angle, the method comprising:
a) chamfering the main edge of the contour to obtain two auxiliary salient edges, associated interior angles of which are respectively greater than the interior angle of the main edge; and
b) blunting the auxiliary edges to fine-tune the contour of the blade root.

11. The method as claimed in claim 10, wherein a) and b) are implemented automatically.

12. The method as claimed in claim 11, wherein the blade root to be adjusted is clamped prior to a) and b) to means mounted so as to rotate about an axis.

13. The method as claimed in claim 12, wherein, before a), the predetermined contour of the blade root is probed to determine a predefined origin on the contour from which the chamfering of a) is begun.

14. The method as claimed in claim 11, wherein the interior angles respectively associated with the auxiliary edges, obtained after a), are identical.

15. The method as claimed in claim 11, wherein b) is carried out by brushing the auxiliary edges using a rotating circular brush having crimped bristles, which is driven in rotation by a longitudinal shaft substantially perpendicular to a general direction of the crimped bristles and to a portion of each of the auxiliary edges currently being brushed.

16. A machine tool for adjusting a predetermined contour of a turbine blade root including a main salient edge defined by a determined interior angle, comprising:
means for chamfering the main edge of the contour to obtain two auxiliary salient edges, associated interior angles of which are respectively greater than the interior angle of the main edge;
means for blunting the auxiliary edges obtained, to fine-tune the contour of the blade root; and
means for automatically controlling the chamfering means and the blunting means.

17. The machine tool as claimed in claim 16, further comprising means, mounted so as to rotate about an axis, to which is clamped the blade root to be adjusted and which means comprises at least one detachable clamping module configured to grip the blade root to be adjusted.

18. The machine tool as claimed in claim 17, wherein the clamping module comprises contact members configured to press against the blade root to be adjusted.
